(19) United States
(12) Patent Application Publication
(10) Pub. No.: US 2011/0162224 A1
(43) Pub. Date: Jul. 7, 2011

(54) CLOTHES DRYER HAVING DRAWER TYPE MIST SUPPLYING DEVICE

(76) Inventors: Sang Hun Bae, Gyeongsangnam-Do (KR); Min-Ji Kim, Gyeongsangnam-Do (KR); Sung-Ho Song, Gyeongsangnam-Do (KR)

(21) Appl. No.: 13/062,100

(22) PCT Filed: Jan. 1, 2010
(86) PCT No.: PCT/KR2010/000591

§ 371 Date: Mar. 3, 2011

(30) Foreign Application Priority Data
Feb. 2, 2009 (KR) 10-2009-0008164
Feb. 2, 2009 (KR) 10-2009-0008166

(51) Int. Cl. F26B 19/00; F26B 25/06

(52) U.S. Cl. 34/60

(57) ABSTRACT

A clothes dryer comprises a body that forms appearance of the clothes dryer, a drum rotatably mounted in the body, at least one drawer configured to be inserted into or withdrawn out of the body, at least one cartridge detachably mounted to the drawer for storing therein liquid to be sprayed into the drum, and a nozzle for spraying the liquid stored in the cartridge into the drum. The liquid stored in the cartridge can be supplied into the drum. Furthermore, since the cartridge is implemented as a drawer type that is easily inserted into or withdrawn out of the body, liquid stored in the cartridge can be easily supplemented or replaced by a new one.

### TECHNICAL FIELD

The present invention relates to a clothes dryer, and more particularly, to a clothes dryer having a drawer type mist or fragrance supplying device capable of spraying liquid into a drum in the form of mist.

### BACKGROUND ART

In general, a clothes dryer indicates an apparatus for drying laundry having completely undergone a dehydration process after a washing process, by introducing the laundry into a drum of the clothes dryer, and by evaporating moisture inside the laundry by supplying hot blast into the drum.

The clothes dryer comprises a drum disposed in the clothes dryer and into which laundry is introduced, a driving motor for driving the drum, a blow fan for blowing air into the drum, and a heating means for heating the air introduced into the drum.

The heating means may use high-temperature electric resistance heat generated by using an electric resistance, or combustion heat generated by combusting gas.

Air having been discharged from the drum contains moisture of the laundry inside the drum, thereby changing into high-temperature humid air. According to a method for processing the high-temperature humid air, the clothes dryer may be classified. More concretely, the clothes dryer is classified into a condensation type clothes dryer for condensing moisture inside high-temperature humid air by heat-exchanging the high-temperature humid air with external air through circulation in the clothes dryer without discharging the high-temperature humid air out of the clothes dryer, and an exhaustion type clothes dryer for directly discharging high-temperature humid air having passed through the drum to the outside.

When drawing the laundry having completely undergone a drying process out of the clothes dryer, it was required to supply a fresh feeling of the laundry to a user, and to remove wrinkles of the laundry. Accordingly, there have been needs to supply a fragrant material into the drum of the clothes dryer during a drying process. Also, required is a means for easily supplementing the fragrant material supplied into the drum when the fragrant material is used up. Especially, required is a means for easily spraying a liquid fragrant material into the drum.

### DISCLOSURE OF INVENTION

### Solution to Problem

Therefore, an object of the present invention is to provide a clothes dryer capable of removing odor from laundry or of depositing fragrance into the laundry.

According to the present invention, there is provided a clothes dryer, comprising: a body that forms appearance of the clothes dryer; a drum rotatably mounted in the body; at least one drawer configured to be inserted into or withdrawn out of the body; and at least one cartridge detachably mounted to the at least one drawer, and storing therein liquid to be sprayed into the drum.

In the present invention, liquid stored in the cartridge may be supplied to the drum of the clothes dryer, and the cartridge may be implemented in a drawer so as to be easily inserted into or withdrawn out of the body. Accordingly, the liquid stored in the cartridge may be easily replaced by a new one, or can be supplemented with the same kind of liquid.

For this, the drawer may be installed on a front upper surface of the body, and may be installed to be withdrawn toward the front surface of the body. And, a guide member for guiding the drawer to be inserted into or withdrawn out of the body may be installed in the body.

The clothes dryer according to the present invention may further comprise at least one nozzle for spraying liquid stored in the cartridge into the drum. By the at least one nozzle, liquid may be sprayed into the drum in the form of mist.

The liquid stored in the cartridge may be a fragrant liquid or water. Accordingly, a fragrant liquid having fragrance or water having undergone an atomization process may be sprayed into the drum in the form of mist by the mist nozzle.

An exit of the mist nozzle may be installed at a front supporter or a rear supporter of the drum so as to be toward the inside of the drum.

A pump may be disposed between the cartridge and the mist nozzle.

The cartridge may be provided with an injection opening through which liquid to be stored in the cartridge is injected, and a cap for opening and closing the injection opening. Accordingly, liquid to be stored in the cartridge may be easily injected into the injection opening.

According to another aspect of the present invention, a first cartridge where a fragrant liquid is stored, and/or a second cartridge where water is stored can be detachably mounted to the drawer. The at least one nozzle is mounted to the rear supporter, and a pump is installed between the first cartridge and/or the second cartridge and the at least one nozzle.

In particular, a first cartridge for storing a fragrant liquid therein and a second cartridge for storing water therein can be detachably mounted to the drawer, so that and the fragrant liquid or water can be sprayed into the drum a nozzle.

The clothes dryer according to the present invention is provided with a mist supplying device for easily spraying a fragrant liquid or water having undergone an atomization process into the drum in the form of mist during a drying process or when the drying process has finished. And, when liquid stored in the mist supplying device is used up, the liquid may be supplemented or replaced by a new one.

Furthermore, in the mist supplying device that is installed at a position to which a user can easily approach, the cartridge for storing liquid therein may be replaced by a new one. by Accordingly, a type of liquid to be sprayed into the drum may be easily changed by replacing the cartridges containing therein various kinds of fragrant liquids or water by new ones.

Preferably, the drawer may be installed on a front upper surface of the body, and may be installed to be withdrawn toward the front surface of the body. And, a guide member for guiding the drawer to be inserted into or withdrawn out of the body may be installed in the body.

The nozzle may be installed at a rear supporter such that an exit thereof is toward the inside of the drum. And, the nozzle sprays liquid stored in the cartridge into the drum in the form of mist.

The fragrant liquid stored in the first cartridge and the water stored in the second cartridge may be mixed with each other at a confluent point thus to be introduced into the pump. A water supply valve for opening and closing a flow path may be provided between the second cartridge and the confluent point. The water supply valve may be implemented as a variable valve for controlling a flow amount of the water passing through the flow path.

A fragrant liquid valve for opening and closing a flow path may be provided between the first cartridge and the confluent point. The fragrant liquid valve may be implemented as a variable valve for controlling a flow amount of the fragrant liquid passing through the flow path.

Therefore, the a concentration of fragrance to be sprayed into a drum can be easily controlled.

In the clothes dryer according to the present invention, a concentration of fragrance sprayed into the drum during a drying process or when the drying process has finished may be easily controlled through a dilution process with using water according to a user's necessity.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a perspective view of a clothes dryer according to a first embodiment of the present invention;

FIG. 2 is a partial perspective view of the clothes dryer of FIG. 1;

FIG. 3 is a perspective view of a cartridge mounted to the clothes dryer of FIG. 1;

FIG. 4 is a perspective view of a clothes dryer according to a second embodiment of the present invention;

FIG. 5 is a partial perspective view of the clothes dryer of FIG. 4; and

FIG. 6 is a perspective view of a drawer-type fragrance supplying device according to a second embodiment of the present invention;

FIG. 7 is a perspective view of a cartridge mounted to the clothes dryer of FIG. 4; and

FIG. 8 is a perspective view of a drawer-type fragrance supplying device according to a third embodiment of the present invention.

### BEST MODE FOR CARRYING OUT THE INVENTION

Description will now be given in detail of the present invention, with reference to the accompanying drawings.

Hereinafter, a clothes dryer having a drawer type mist supplying device according to the present invention will be explained in more detail.

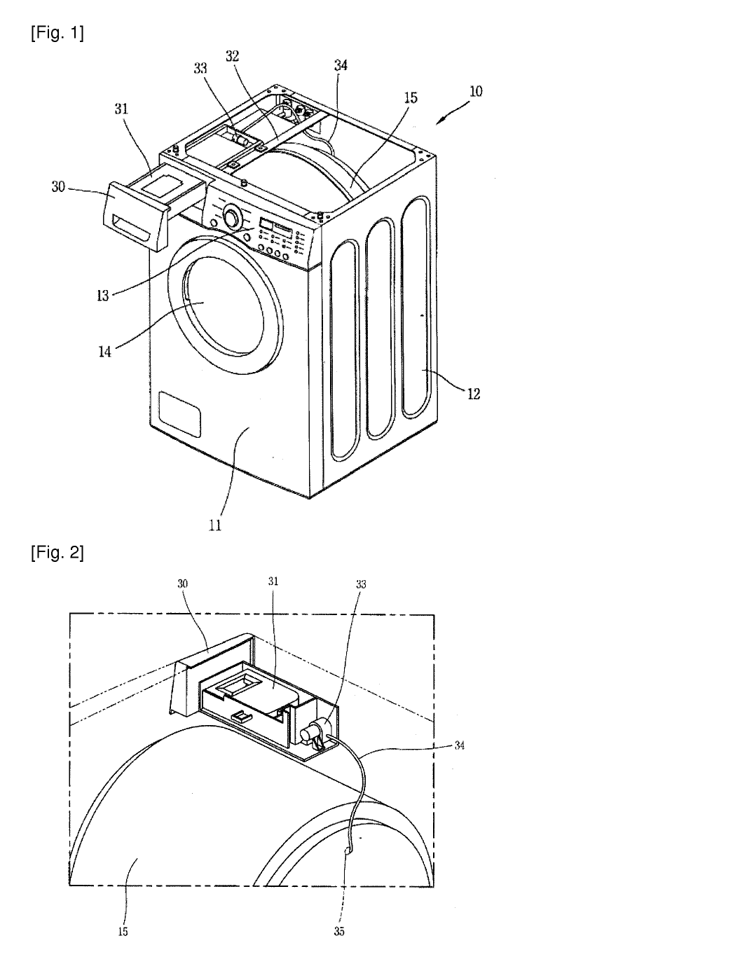

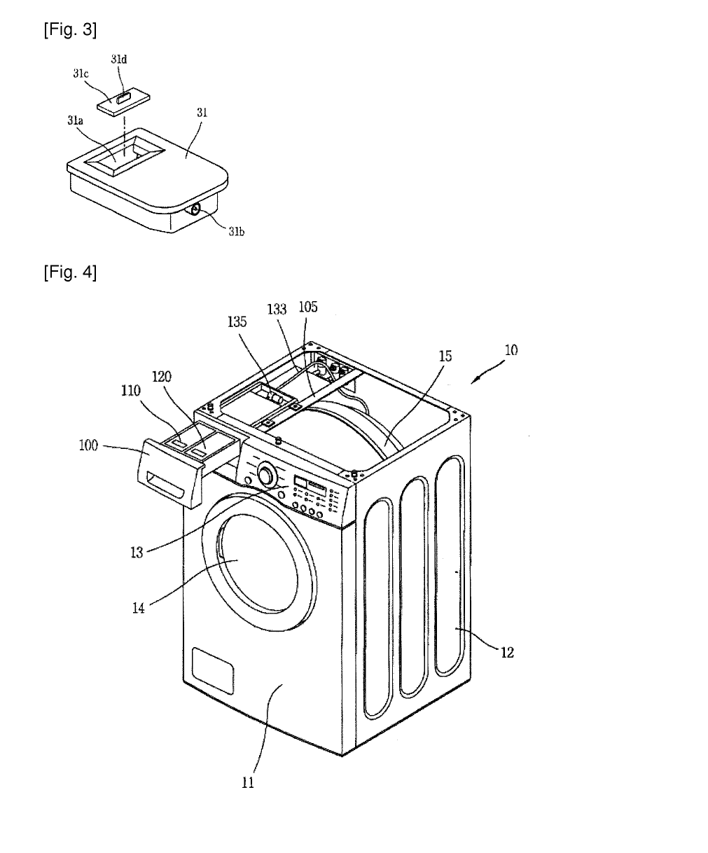

FIG. 1 is a perspective view of a clothes dryer according to a first embodiment of the present invention, FIG. 2 is a partial perspective view of the clothes dryer of FIG. 1, and FIG. 3 is a perspective view of a cartridge mounted to the clothes dryer of FIG. 1.

Referring to FIGS. 1 and 2, the clothes dryer 10 according to the present invention comprises a front cover 11 that forms appearance thereof, a side cover 12, a top plate (not shown), and a drum 15 rotatably installed therein and into which laundry is introduced. And, the clothes dryer 10 comprises a front supporter (not shown) mounted to a rear surface of the front cover 11 for supporting a front opening of the drum 15, a door 14 mounted to a front surface of the front cover 11 for opening and closing the front opening of the drum 15, and a control panel 13 disposed at an upper part of the front cover 11 and having each kind of buttons for inputting drying conditions.

Although not shown, the clothes dryer 10 also comprises a blow fan for making air inside the drum 15 circulate in the clothes dryer 10, a heater for heating air introduced into the drum 15 by the blow fan after being discharged from the drum 15, etc. Below the drum 15, formed is a flow path of external air that condenses moisture included in circulation air by being heat-exchanged with the circulation air inside the clothes dryer 10. A condenser for heat-exchanging circulation air with external air is disposed below the drum 15.

For convenience, FIG. 2 illustrates only the drum 15 disposed in the clothes dryer, and a mist supplying device for supplying liquid in the form of mist.

Referring to FIGS. 1 and 2, the clothes dryer having a drawer type mist supplying device according to a first embodiment of the present invention comprises a drawer 30 configured to be inserted into or withdrawn out of the front cover 11 of a body of the clothes dryer, and a cartridge 31 detachably mounted to the drawer 30 for storing liquid therein. The drawer 30 is installed at an upper part of the front cover 11 of the clothes dryer 10 so as to be withdrawn toward a front side of the body, Preferably, the drawer 30 is installed at a side surface of the control panel 13 disposed at an upper part of the front cover 11.

The clothes dryer 10 comprises a guide member 32 for guiding the drawer 30 when the drawer 30 is inserted into or withdrawn out of the clothes dryer 10. A pump 33 for compressing liquid injected into the drum 15 of the clothes dryer 10 is connected to the inside of the drawer 30. The liquid stored in the cartridge is compressed by a suitable pressure while passing through the pump 33, and then is sprayed into the drum 15.

The pump 33 and the cartridge 31 are communicated with each other through pipes provided thereat.

A hose 34 is connected to an exit of the pump 33, thereby guiding liquid compressed by the pump 33 to the drum 15. And, a nozzle 35 is provided at the end of the hose 34 disposed at the drum side. The liquid pressed by the pump 33 and guided into the drum 15 through the hose 34 and the nozzle 35 to be made into a mist form, thereby sprayed into the drum 15. The reason is because particles sprayed in the form of mist rather than in the form of liquid can be more effectively deposited onto clothes. For this, the hose 34 and the nozzle 35 are preferably installed at the rear supporter that supports a rear surface of the drum 15. However, the hose 34 and the nozzle 35 may be installed at the front supporter that supports a front surface of the drum 15.

FIG. 3 is a perspective view of the cartridge mounted to the clothes dryer of FIG. 1. The cartridge 31 is provided, on its upper surface, with an injection opening 31a through which liquid is injected. And, the cartridge 31 is provided, on its side surface, with a discharge port or opening 31b through which liquid stored therein is discharged out to the pump 33. In particular, the discharge port or opening 31b is provided with regard to the insertion direction of the cartridge 31 on a front side surface thereof that faces coupling or connecting means (not shown) for connecting the cartridge 31 with the pump 33.

Preferably, the cartridge 31 is provided with a cap 31c for opening and closing the injection opening 31a after liquid has been injected into the injection opening 31a. A handgrip 31d held by a user to open and close the injection opening 31a is provided on the cap 31c. Preferably, a sealing means is provided between the cap 31c and the cartridge 31 thus to prevent liquid stored in the cartridge 31 from being evaporated.

The liquid stored in the cartridge 31 and sprayed into the drum 15 via the pump 33 and the hose 34 is a fragrant liquid or water. According to a drying course or a user's preference, a fragrant liquid may be injected into the cartridge 31, and made into a mist form through the nozzle 35 thus to be sprayed into the drum 15. Alternatively, water may be stored in the cartridge 31, and made into a mist form by the nozzle 35 and sprayed into the drum 15.

Hereinafter, will be explained the operation of the clothes dryer 10 according to the present invention.

Firstly, a fragrant liquid or water is injected into the injection opening 31a of the cartridge 31, and the cap 31c is closed. Then, the cartridge 31 is mounted to the drawer 30. Once the drawer 30 is inserted into the clothes dryer, the drawer 30 is mounted in the clothes dryer along the guide member 32. Here, the discharge port or opening 31b of the cartridge 31 is in a closed state at ordinary times. However, when the drawer 30 has been completely mounted to the clothes dryer 10, the discharge port or opening 31b is coupled to and opened by the coupling or connecting means so as to be in communication with the pump 33.

Once the clothes dryer 10 is operated as a user selects a drying course, the mist supplying device sprays the liquid stored in the cartridge 31 into the drum 15 in the form of mist under control of a microprocessor. The time when the mist is sprayed into the drum 15, or the amount of the mist may be determined as the user presses a specific button on the control panel 13 at a specific time. Alternatively, the spray time or the amount of the mist may be automatically determined according to an algorithm of a drying course selected by the user.

The cartridge 31 may be provided in plurality in number, so that various types of fragrant liquid can be individually contained in the cartridges 31. Once one cartridge 31 containing a user's desired fragrant liquid therein among the plurality of cartridges 31 is inserted into the drawer 30 for spraying during a drying process, a unique fragrance of the selected fragrant liquid can be deposited on clothes. Alternatively, some of the cartridges 31 may store water therein, and the water may undergo an atomization process thus to be supplied into the drum 15. Accordingly, can be implemented refreshing functions such as a wrinkle removal process and a deodorization process for laundry.

According to a another embodiment of the present invention, there may be provided a clothes dryer wherein either a first cartridge for storing a fragrant liquid, or a second cartridge for storing water is detachably mounted to the drawer 30. Also, there may be provided a clothes dryer wherein either a first cartridge for storing a first fragrant liquid, or a second cartridge for storing a second fragrant liquid is detachably mounted to the drawer 30.

Under these configurations, a liquid material such as a fragrant liquid or water stored in the cartridge is made into a mist form, thus to be easily supplied into the drum of the clothes dryer. Furthermore, the cartridge is implemented as a drawer type that can be easily inserted into or withdrawn out of the body. Accordingly, when liquid stored in the cartridge is used up, the same kind of liquid can be supplied to the cartridge for supplement. Also, when a user wants another fragrance, the existing cartridge can be easily replaced by a new cartridge containing the user's desired fragrance.

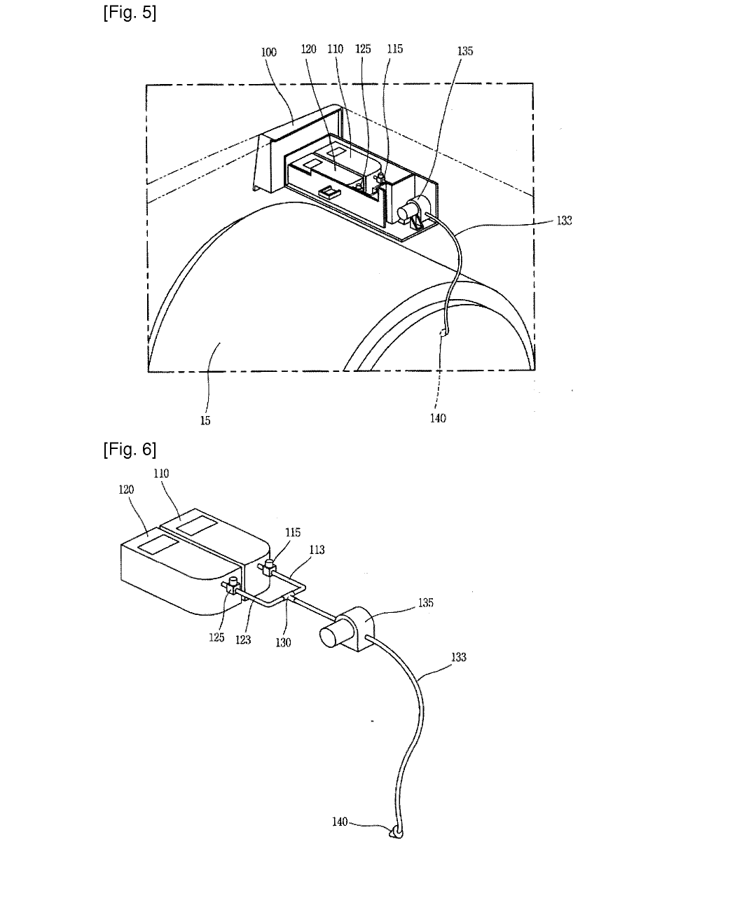

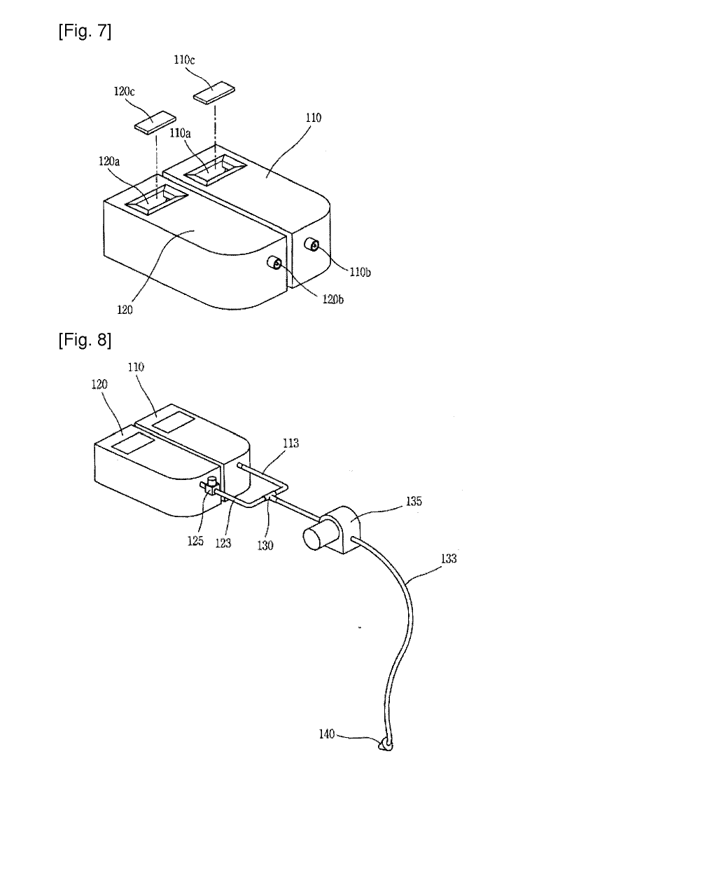

FIG. 4 is a perspective view of a clothes dryer according to a second embodiment of the present invention, FIG. 5 is a partial perspective view of the clothes dryer of FIG. 4, and FIG. 6 is a perspective view of a drawer-type fragrance supplying device according to the second embodiment of the present invention, and FIG. 7 is a perspective view of a cartridge mounted to the clothes dryer of FIG. 4.

Referring to FIGS. 4 to 3, the clothes dryer 10 according to the present invention comprises a front cover 11 that forms appearance thereof, a side cover 12, a top plate (not shown), and a drum 15 rotatably installed therein and into which laundry is introduced. And, the clothes dryer 10 comprises a front supporter (not shown) mounted to a rear surface of the front cover 11 for supporting a front opening of the drum 15, a door 14 mounted to a front surface of the front cover 11 for opening and closing the front opening of the drum 15, and a control panel 13 disposed at an upper part of the front cover 11 and having each kind of buttons for inputting drying conditions.

Although not shown, the clothes dryer 10 also comprises a blow fan for making air inside the drum 15 circulate in the clothes dryer 10, a heater for heating air introduced into the drum 15 by the blow fan after being discharged from the drum 15, etc. Below the drum 15, formed is a flow path of external air that condenses moisture included in circulation air by being heat-exchanged with the circulation air inside the clothes dryer 10. A condenser for heat-exchanging circulation air with external air is disposed below the drum 15.

The drawer-type fragrance supplying device for the clothes dryer according to a first embodiment includes a drawer 100 configured to be inserted into or withdrawn out of the front cover 11 of a body of the clothes dryer, and cartridges 110 and 120 detachably mounted to the drawer 100 for storing liquid therein. The drawer 100 is installed at an upper part of the front cover 11 of the clothes dryer 10 so as to be withdrawn toward a front side of the body, Preferably, the drawer 100 is installed at a side surface of the control panel 13 disposed at an upper part of the front cover 11.

The clothes dryer further comprises a guide member 105 for guiding the drawer 100 to be inserted into or withdrawn out of the body. And, a pump 135 for compressing liquid sprayed into the drum is provided in the clothes dryer. Under this configuration, liquid stored in the cartridges 110 and 120 so as to be sprayed into the drum 15 is compressed by a suitable pressure while passing through the pump 135.

The cartridges detachably mounted to the drawer 100 consist of a first cartridge 110 for storing a fragrant liquid, and a second cartridge 120 for storing water. Accordingly, in the present invention, either the fragrant liquid stored in the first cartridge 110, or the water stored in the second cartridge 120 may be supplied into the drum 15 of the clothes dryer. Alternatively, the mixture between the fragrant liquid inside the first cartridge 110 and the water inside the second cartridge 120 may be supplied to the drum 15 of the clothes dryer.

The clothes dryer 10 according to the second embodiment of the present invention comprises a first hose 113 for guiding a fragrant liquid discharged from the first cartridge 110, and a second hose 123 for guiding water discharged from the second cartridge 120.

The first hose 113 and the second hose 123 are made to meet each other at a confluent point 130, and then are guided into the drum 15 by a third hose 133. A nozzle 140 is provided at the end of the third hose 133. The fragrant liquid or water or a mixture thereof passing through the third hose 133 are compressed by the pump 135 provided at the third hose 133, and are made into a mist form by the nozzle 140. Then, the fragrant liquid or water or the mixture thereof in the form of mist are sprayed into the drum 15. The reason is because particles sprayed in the form of mist rather than in the form of liquid can be more effectively deposited onto clothes. The nozzle 140 is preferably installed on a rear surface of the drum 15. However, the position of the nozzle 140 is not limited to this, but may be installed on a front surface of the drum 15.

First and second output control means for opening and closing a flow path are provided between each of the cartridges (110, 120) and the confluent point (130). The output control means may be implemented as a throttle, a variable throttle or as a valve for controlling a flow amount of liquid passing through the flow path.

In detail, the first hose 113 for connecting the first cartridge 110 and the confluent point 130 to each other is provided with a first valve 115 as a first output control means for opening and closing a flow path. The first valve 115 may be preferably implemented as a variable valve for controlling a flow amount of a fragrant liquid passing through the flow path.

The second hose 123 for connecting the second cartridge 120 and the confluent point 130 to each other is provided with a second valve 125 as a second output control means for opening and closing a flow path. The second valve 125 may be implemented as a variable valve for controlling a flow amount of water passing through the flow path. The first valve 115 and the second valve 125 are preferably implemented as solenoid valves.

The first and second output control means are electrically controlled by selecting means operable by a user. The selecting means comprises e.g. at least a specific button on the control panel 13 that is connected to selecting circuit (not shown) operating the output control means. The selecting means for selecting and controlling spray time and/or the amount of the mist may be alternatively implemented as a part of an algorithm of a drying course that can be selected by the user by operating the control panel. In the latter case the spraying step is automatically determined according to the selected drying or refreshing course or the like. Thus, the user can select or control spraying time and/or amount and/or fragrance concentration of the mist to be sprayed by suitable operating the operating means on the control panel (13).

By opening or closing one of the first and second valves 115 and 125, one of a fragrant liquid stored in the first cartridge and water stored in the second cartridge can be supplied into the drum 15. More concretely, in a mode to supply only fragrance into the drum 15, the first valve 115 is opened but the second valve 125 is closed, thereby spraying only the fragrant liquid into the drum 15. However, in a mode to supply only water into the drum 15, the first valve 115 is closed but the second valve 125 is opened, thereby supplying water in the form of mist into the drum 15.

It is also possible to control a mixture amount between the fragrant liquid and water by controlling opened degrees of the first and second valves 115 and 125. Accordingly, a user can supply the fragrant liquid to the drum 15 after diluting the fragrant liquid by mixing the water to the fragrant liquid. More concretely, when a fragrant liquid having a high concentration is to be supplied into the drum 15, the first valve 115 is much opened, but the second valve 125 is opened a little. However, when a fragrant liquid having a low concentration is to be supplied into the drum 15, the first valve 115 is opened a little, but the second valve 125 is much opened. Under this configuration, fragrant liquids having various concentrations can be supplied into the drum 15 of the clothes dryer 10.

FIG. 7 shows the first cartridge 110 and the second cartridge 120 according to a second embodiment of the present invention.

The first and second cartridges 110 and 120 are provided, on upper surfaces thereof, with injection openings 110a and 120a through which liquid is injected into the first and second cartridges 110 and 120, respectively. And, the first and second cartridges 110 and 120 are provided, on side surfaces, in particular on front side surfaces thereof, with discharge ports or openings 110b and 120b through which the liquids stored in the first and second cartridges 110 and 120 are discharged out.

Furthermore, the first and second cartridges 110 and 120 are respectively provided with caps 110c and 120c, respectively, so as to open and close the injection openings 110a and 120a after injecting liquids into the injection openings 110a and 120a.

FIG. 8 is a perspective view of a drawer-type fragrance supplying device according to a third embodiment of the present invention.

Differently from the second embodiment where both the first valve 115 and the second valve 125 are provided as shown in FIG. 3, one of the first and second valves 115 and 125 is provided in the third embodiment. For instance, the first valve 115 disposed at the first hose 113 is not provided, but the second valve 125 disposed at the second hose 123 is provided. That is, the fragrant liquid discharged from the first cartridge 110 may be introduced into the confluent point 130 as it is. However, the water discharged from the second cartridge 120 may have its flow amount controlled by the second valve 125, and then flow into the confluent point 130. When supplying a fragrant liquid having a high concentration into the drum 15, the second valve 125 is opened a little. However, when supplying a fragrant liquid having a low concentration into the drum 15, the second valve 125 is much opened to supply a large amount of water into the confluent point 130.

Hereinafter, will be explained the operation of the clothes dryer according to the present invention.

Firstly, a fragrant liquid and water are injected into the injection openings 110a and 120a of the cartridges 110 and 120, and the caps 110c and 120c are closed. Then, the cartridges 110 and 120 are mounted to the drawer 100. Once the drawer 100 is inserted into the clothes dryer, the drawer 100 is mounted in the clothes dryer along the guide member 105. Here, the discharge openings 110b and 120b of the cartridges 110 and 120 are in a closed state at ordinary times, respectively. However, when the drawer 100 has been completely mounted to the guide member 105, the discharge openings 110b and 120b are opened similarly as described in connection with the first embodiment above.

Once the clothes dryer is operated as a user selects a drying course, the drawer-type fragrance supplying device with the dual cartridges sprays the fragrant liquid inside the first cartridge 110 or water inside the second cartridge 120, at a suitable time, into the drum 15 in the form of mist under control of a microprocessor. The time when the mist is sprayed into the drum 15, or the amount of the mist, or the concentration of fragrance of the mist may be determined as the user presses the specific button or specific buttons on the control panel 13 at a specific time. Alternatively, the spray time or the amount of the mist or the concentration of fragrance of the mist may be automatically determined according to an algorithm of a drying course selected by the user.

The first cartridge 110 may be provided in plurality in number, so that various types of fragrant liquids can be individually stored in the first cartridges 110. Once one cartridge containing a user's desired fragrant liquid therein among the plurality of first cartridges 110 is inserted into the drawer 100 for liquid spray during a drying process, a unique fragrance of the selected fragrant liquid can be deposited on clothes. In this manner, the user can deposit various types of fragrance onto clothes according to his or her preference. Alternatively, the water stored in the second cartridge 120 may undergo an atomization process thus to be supplied into the drum 15. Accordingly, can be implemented refreshing functions such as a wrinkle removal process and a deodorization process for laundry. It is also possible to mix the fragrant liquid stored in the first cartridge 110 with the water stored in the second cartridge 120 in a suitable ratio, and then to supply the mixture into the drum 15. This may allow fragrance having the user's desired concentration to be supplied into the drum 15.

Under these configurations, a liquid material such as a fragrant liquid or water is made into a mist form, thus to be easily supplied into the drum of the clothes dryer. Furthermore, the fragrant liquid may have a controlled concentration by being mixed the water, thus to be sprayed into the drum.

Also, the cartridges are implemented as types of drawers that can be easily inserted into or withdrawn out of the body. Accordingly, when the fragrant liquid stored in the first cartridge or water stored in the second cartridge is used up, the fragrant liquid or water can be easily supplemented by a user. When the user wants another fragrance, the existing cartridge mounted to the drawer can be easily replaced by a new cartridge containing the user's favored fragrance.

In the present invention, a condensation type clothes dryer was explained. However, the present invention is not limited to this, but may be applied to an exhaustion type clothes dryer or a ductless clothes dryer.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

1. A clothes dryer (10), comprising:
a body (11) that forms appearance of the clothes dryer (10);
a drum (15) rotatably mounted in the body;
at least one drawer (30; 100) configured to be inserted into or withdrawn out of the body (11); and
at least one cartridge (31; 110, 120) detachably mounted to the at least one drawer (30; 100), and storing therein liquid to be sprayed into the drum (15).

2. The clothes dryer of claim 1, comprising one drawer (100), on which a first cartridge (110) and a second cartridge (120) are detachably mounted.

3. The clothes dryer of claim 1, further comprising at least one nozzle (35; 140) for spraying the liquid stored in a cartridge into the drum (15).

4. The clothes dryer of claim 1, wherein the at least one drawer is installed at a front upper part of the body so as to be withdrawn toward a front surface of the body.

5. The clothes dryer of claim 1, wherein a guide member for guiding the at least one drawer to be inserted into or withdrawn out of the body is installed in the body.

6. The clothes dryer of claim 5, wherein the liquid sprayed into the drum from the at least one nozzle is in a mist form.

7. The clothes dryer of claim 6, wherein the at least one nozzle is installed at a front side or a rear side of the drum such that an exit thereof is toward inside of the drum.

8. The clothes dryer of claim 7, wherein at least one pump (33; 135) is disposed between a cartridge and the at least one nozzle.

9. The clothes dryer of claim 1, wherein the liquids from different cartridges (110, 120) are mixed with each other at a confluent point (130).

10. The clothes dryer of claim 9, wherein the pump (135) is disposed between the confluent point (130) and the nozzle (140).

11. The clothes dryer of claim 9, wherein output control means for opening and closing a flow path is provided between at least one of the cartridges (120) and the confluent point (130).

12. The clothes dryer of claim 11, wherein the output control means is implemented as a variable valve, in particular as a variable solenoid valve for controlling a flow amount of liquid passing through the flow path.

13. The clothes dryer of claim 1, wherein the cartridge comprises:
an injection opening (31a) through which liquid to be stored in the cartridge is injected; and
a cap (31c) for opening and closing the injection opening (31a).

14. The clothes dryer of claim 1, wherein the cartridge comprises a discharge port or opening (31b) provided with regard to the insertion direction of the cartridge (31) into the drawer (30)—on a front side surface thereof.

15. The clothes dryer of claim 14, wherein the output control means are electrically controlled by selecting means operable by a user via operating means provided on a control panel (13) so as to control spraying time and/or amount and/or fragrance concentration of the mist to be sprayed.
